(19) United States
(12) Patent Application Publication
(10) Pub. No.: US 2022/0195573 A1
(43) Pub. Date: Jun. 23, 2022

(54) ALUMINUM ALLOY FORGING AND METHOD OF PRODUCING THE SAME

(71) Applicant: SHOWA DENKO K.K., Tokyo (JP)

(72) Inventor: Takuya ARAYAMA, Kitakata-shi (JP)

(73) Assignee: SHOWA DENKO K.K., Tokyo (JP)

(21) Appl. No.: 17/548,769

(22) Filed: Dec. 13, 2021

(30) Foreign Application Priority Data
Dec. 14, 2020 (JP) 2020-206753

(51) Int. Cl. C22F 1/057; C22C 21/14; C22C 21/16; B21J 5/02

(52) U.S. Cl. CPC C22F 1/057; B21J 5/02; C22C 21/16; C22C 21/14

(57) ABSTRACT

An aluminum alloy forging of the present invention includes 0.15 wt % to 1.0 wt % of Cu, 0.6 wt % to 1.3 wt % of Mg, 0.60 wt % to 1.45 wt % of Si, 0.03 wt % to 1.0 wt % of Mn, 0.2 wt % to 0.4 wt % of Fe, 0.03 wt % to 0.4 wt % of Cr, 0.012 wt % to 0.035 wt % of Ti, 0.0001 wt % to 0.03 wt % of B, 0.25 wt % or less of Zn, 0.05 wt % or less of Zr, the balance being Al and inevitable impurities. When integrated intensity of a diffraction peak of an AlFeMnSi phase in an X-ray diffraction pattern obtained by an X-ray diffraction measurement of a cross-section of the forging is “Q₁” (cps·deg) and integrated intensity of a diffraction peak of a (200) plane of an Al phase is “Q₂” (cps·deg), a value of Q₁/Q₂ is 6×10⁻² or less.

### TECHNICAL FIELD

The present invention relates to an Al—Mg—Si based aluminum alloy forging excellent in mechanical properties at normal temperature and a method of producing the same.

### BACKGROUND OF THE INVENTION

In recent years, an aluminum alloy has been expanding its application as a structural member for various products by taking advantage of its lightness. For example, high tension steel has been used for a suspension system and bumper parts of an automobile until now, but a high strength aluminum alloy material has been recently become to be used. For example, an iron-based material has been used exclusively for automobile components, such as, e.g., suspension parts. However, for weight reduction as a primary object, an iron-based material has often been replaced with an aluminum or aluminum alloy material.

These automobile components are required to be excellent in corrosion resistance, high in strength, and superior in formability. Therefore, as an aluminum alloy for these automobile components, an Al—Mg—Si based alloy, particularly an A6061 aluminum alloy, has been widely used. In order to improve strength, such an automobile component is produced by performing a forging process, which is one of plastic workings, using an aluminum alloy material as a processing material.

Further, since it is required to reduce the cost, a suspension part obtained by subjecting a casting member as a raw material to a forging process as it is without performing extrusion and then subjecting the forged product to a T6 treatment has recently begun to be put into practical use. For further weight reduction, the development of a high-strength alloy to be replaced with a conventional A6061 aluminum alloy has been progressed (see Patent Documents 1 to 3 listed below).

### PRIOR ART DOCUMENT

### Patent Document

Patent Document 1: Japanese Unexamined Patent Application Publication No. H5-59477
Patent Document 2: Japanese Unexamined Patent Application Publication No. H5-247574
Patent Document 3: Japanese Unexamined Patent Application Publication No. H6-256880

### SUMMARY OF THE INVENTION

### Problems to be Solved by the Invention

However, in the above-described high-strength Al—Mg—Si based alloy, the processing structure recrystallizes during the forging step and the heat treatment step, causing coarse crystal grains. This prevents attaining sufficient high strength. Therefore, in order to prevent the formation of coarse recrystallized grains, there has been known an alloy in which Zr is added to prevent recrystallization (for example, Patent Documents 1 and 2 listed above).

However, although adding Zr is effective in preventing recrystallization, there were the following problems.

(1) Adding Zr weakens the crystal grain miniaturization effect of the Al—Ti—B based alloy, causing coarse crystal grains of the ingot itself, which in turn results in strength reduction of the workpiece (forging) after plastic working.

(2) The crystal grain miniaturization effect of the ingot itself is weakened, readily causing ingot cracking. This increases the internal defect, which in turn deteriorates the yield.

(3) Zr forms compounds with an Al—Ti—B based alloy. The compounds deposit on the bottom of the furnace for storing an alloy molten metal, contaminating the furnace. Also in the produced ingot, the above-described compounds are coarsely crystallized in the ingot to lower the strength.

Thus, although adding Zr is effective in preventing recrystallization, it has been difficult to maintain the stability of strength.

Preferred embodiments of the present invention have been made in view of the above-described and/or other problems in the related art. Preferred embodiments of the present invention can significantly improve upon existing methods and/or devices.

The present invention has been made in view of the above-mentioned technical background. An object of the present invention is to provide an aluminum alloy forging excellent in mechanical properties at normal temperature and hard to generate recrystallized grains, and also to provide a process for producing the aluminum alloy forging.

Other objects and advantages of the present invention will be apparent from the following preferred embodiments.

### Means for Solving the Problem

In order to achieve the above-described objects, the present invention provides the following means.

[1] An aluminum alloy forging consisting of:

0.15 to 1.0 mass % of Cu; 0.6 mass % to 1.3 mass % of Mg; 0.60 mass % to 1.45 mass % of Si; 0.03 mass % to 1.0 mass % of Mn; 0.2 mass % to 0.4 mass % of Fe; 0.03 mass % to 0.4 mass % of Cr; 0.012 mass % to 0.035 mass % of Ti; 0.0001 mass % to 0.03 mass % of B; 0.25 mass % or less of Zn; 0.05 mass % or less of Zr; and the balance being Al and inevitable impurities,

wherein, when integrated intensity of a diffraction peak of an AlFeMnSi phase in an X-ray diffraction pattern obtained by an X-ray diffraction measurement of a cross-section of the forging is “Q₁” (cps·deg) and integrated intensity of a diffraction peak of a (200) plane of an Al phase is “Q₂” (cps·deg), a value of Q₁/Q₂ is 6×10⁻² or less.

[2] A method of producing the aluminum alloy forging as recited in the above-described Item [1], the method comprising:

a molten metal forming step of obtaining a molten metal;

a casting step of obtaining a casting by subjecting the molten metal obtained in the molten metal forming step to a casting process;

a homogenization heat treatment step of subjecting the casting obtained in the casting step to a homogenization heat treatment;

a forging step of obtaining a forging by subjecting the casting after the homogenization heat treatment step to a forging process;

a solution treatment step of subjecting the forging obtained in the forging step to a solution treatment;

a quenching treatment step of quenching the forging after the solution treatment step; and

an aging treatment step of subjecting the forging after the quenching treatment step to an aging treatment.

[3] The method of producing an aluminum alloy forging as recited in the above-described Item [2],

wherein the homogenization heat treatment step performs a homogenization heat treatment of holding the casting obtained in the casting step at a temperature of 370° C. to 560° C. for 4 hours to 10 hours,

wherein the forging step performs the forging process on the casting after the homogenization heat treatment step at a heating temperature of 450° C. to 560° C.,

wherein the solution treatment step performs a solution treatment of raising a temperature from 20° C. to 500° C. at a temperature rising rate of 5.0° C./min or more and holding the forging at a temperature of 530° C. to 560° C. for 0.3 hours to 3 hours, on the forging obtained in the forging step,

wherein the quenching treatment step performs a quenching treatment of bringing an entire surface of the forging brought into contact with quenching water within 5 to 60 seconds after the solution treatment step in a water bath for more than 5 minutes and 40 minutes or less, and

wherein the aging treatment step performs an aging treatment of heating the forging after the quenching treatment step at a temperature of 180° C. to 220° C. for 0.5 to 1.5 hours.

### Effects of the Invention

According to the invention as recited in the above-described Item [1], the content of each element is set within the predetermined range, and the value of Q₁/Q₂ is 6×10⁻² or less. Therefore, it is possible to provide an aluminum alloy forging excellent in mechanical properties at normal temperature and hard to generate recrystallized grains.

According to the invention as recited in the above-described Item [2], the present invention includes the molten metal forming step, the casting step, the homogenization heat treatment step, the forging step, the solution treatment step, the quenching treatment step, and the aging treatment step. Therefore, it is possible to produce an aluminum alloy forging excellent in mechanical properties at normal temperature and hard to generate recrystallized grains.

According to the invention as recited in the above-described Item [3], the processing condition in each processing step is set within the predetermined range. Therefore, it is possible to produce an aluminum alloy forging excellent in mechanical properties at normal temperature and hard to generate recrystallized grains.

### BRIEF DESCRIPTION OF THE DRAWINGS

FIG. 1 is a perspective view showing an aluminum alloy forging obtained by the production method of the present invention.

### EMBODIMENTS FOR CARRYING OUT THE INVENTION

An aluminum alloy forging and a method of producing the aluminum alloy forging according to the present invention will be described.

Note that the embodiments described below are merely illustrative, and the present invention is not limited to the embodiments and can be appropriately modified without departing from the technical concept of the present invention.

An aluminum alloy forging 1 of this embodiment consists of:

0.15 to 1.0 mass % of Cu; 0.6 mass % to 1.3 mass % of Mg; 0.60 mass % to 1.45 mass % of Si; 0.03 mass % to 1.0 mass % of Mn; 0.2 mass % to 0.4 mass % of Fe; 0.03 mass % to 0.4 mass % of Cr; 0.012 mass % to 0.035 mass % of Ti; 0.0001 mass % to 0.03 mass % of B; 0.25 mass % or less of Zn; 0.05 mass % or less of Zr; and the balance being Al and inevitable impurities,

wherein, when an integrated intensity of a diffraction peak of an AlFeMnSi phase in an X-ray diffraction pattern obtained by an X-ray diffraction measurement of a cross-section of the forging is “Q₁” (cps·deg) and an integrated intensity of a diffraction peak of a (200) plane of an Al phase is “Q₂” (cps·deg), a value of Q₁/Q₂ is 6×10⁻² or less.

As described above, the content of each element is set within the predetermined range, and the value of Q₁/Q₂ is 6×10⁻² or less. Therefore, it is possible to provide an aluminum alloy forging excellent in mechanical properties at normal temperature and hard to generate recrystallized grains.

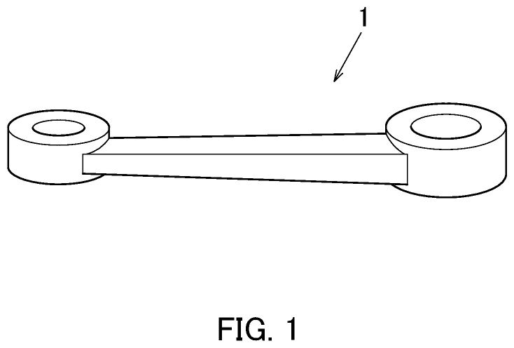

The method of producing the aluminum alloy forging 1 according to the present embodiment produces an aluminum alloy forging 1, for example, as shown in FIG. 1 by performing a molten metal forming step, a casting step, a homogenization heat treatment step, a forging step, a solution treatment step, a quenching treatment step, and an aging treatment step in this order. Hereinafter, each step will be described.

### (Molten Metal Forming Step)

The molten metal forming step is a step of obtaining an aluminum alloy molten metal prepared by dissolving raw materials and adjusting the composition.

In this embodiment, a 6000 series aluminum alloy molten metal is obtained (prepared). The aluminum alloy molten metal consists of 0.15 to 1.0 mass % of Cu; 0.6 mass % to 1.3 mass % of Mg; 0.60 mass % to 1.45 mass % of Si; 0.03 mass % to 1.0 mass % of Mn; 0.2 mass % to 0.4 mass % of Fe; 0.03 mass % to 0.4 mass % of Cr; 0.012 mass % to 0.035 mass % of Ti; 0.0001 mass % to 0.03 mass % of B; 0.25 mass % or less of Zn; 0.05 mass % or less of Zr; and the balance being Al and inevitable impurities. In this aluminum alloy molten metal, the Zn content may be 0 mass % (Zn-free), and the Zr content may be 0 mass % (Zr-free).

### (Casting Step)

The casting step is a step of obtaining a casting by subjecting the aluminum alloy molten metal obtained by the molten metal forming step to a casting process.

The continuous casting method for obtaining the casting may be, but not limited thereto, various known continuous casting methods (a vertical-type continuous casting method, a horizontal-type continuous casting method, etc.). As the vertical continuous casting method, a hot top casting method and the like are used. In the following description, a brief description will be given to the case in which an aluminum alloy continuously cast material is produced by a hot top casting method using a hot top casting apparatus as an example of a continuous casting method (that is, the case in which a molten metal of an aluminum alloy is continuously cast by a hot top casting method to produce an aluminum alloy continuously cast material).

A hot top casting apparatus is provided with a mold, a molten metal receptor (header), and the like. The mold is cooled by cooling water filled therein. The receptor is generally made of refractory material and is placed above the mold. The aluminum alloy molten metal in the receptor is injected downward into the cooled mold, cooled and solidified at a predetermined cooling rate by the cooling water spouted from the mold, and further immersed in water in a water bath (its temperature: about 20° C.) to be completely solidified. With this, an elongated continuously cast material such as an elongated rod is obtained.

### (Homogenization Heat Treatment Step)

The homogenization heat treatment step is a step in which the cast material obtained at the casting step is subjected to a homogenization heat treatment to cause homogenization of micro segregation caused by solidification, precipitation of a supersaturated solid solution element, and a change of a metastable phase to an equilibrium phase.

In this embodiment, the casting obtained at the casting step is subjected to a homogenization heat treatment at the temperature of 370° C. to 560° C. for 4 hours to 10 hours. The homogenization heat treatment performed at the temperature results in sufficient homogenization of the ingot and melting of the solute atom. Therefore, required sufficient strength can be obtained by the subsequent aging treatment.

### (Forging Step)

The forging step is a step in which a forging billet obtained after the homogenization heat treatment step is heated and die-molded by pressurizing with a press machine.

In this embodiment, the ingot after the homogenization heat treatment is subjected to a forging process at a heating temperature in the range of 450° C. to 560° C. to obtain a forging (e.g., a suspension arm component for an automobile). At this time, the starting temperature for forging the forging material is set to the range of 450° C. to 560° C. The reason is as follows. When the starting temperature is lower than 450° C., the deformation resistance increases, preventing sufficient processing. On the other hand, when the starting temperature exceeds 560° C., defects, such as, e.g., forging cracking and eutectic melting, are likely to occur.

### (Solution Treatment Step)

The solution treatment step is a step of relaxing the strain introduced at the forging step and solid-soluting the solute element.

In this embodiment, the solution treatment is performed as follows. The temperature of the forging after the forging step is lowered to 20° C. Thereafter, heating is started when the temperature of the forging has reached the room temperature and hold the forging while raising the temperature always at the temperature rising rate of 5.0° C./min or more in the entire temperature range of 20° C. to 500° C. and hold the forging at the temperature in the range of 530° C. to 560° C. for 0.3 hours to 3 hours.

When the temperature rising rate is less than 5.0° C./min, coarse precipitation of Mg₂Si occurs. When the processing temperature is lower than 530° C., the solution treatment will not be promoted, which fails to realize the high strengthening by age precipitation. When the processing temperature exceeds 560° C., although the solid solution of the solute element is further promoted, eutectic melting and recrystallization are likely to occur.

### (Quenching Treatment Step)

The quenching treatment step is a heat treatment for forming a supersaturated solid solution by rapidly cooling the solid solution obtained by the solution treatment step.

In this embodiment, the entire surface of the forging is brought into contact with quenching water within the range of 5 seconds to 60 seconds after the solution treatment to perform the quenching treatment in a water bath for more than 5 minutes and less than 40 minutes.

### (Aging Treatment Step)

The aging treatment step is a heat treatment for imparting appropriate hardness by heating and holding an aluminum alloy forging at a relatively low temperature to cause precipitation of the supersaturated solid solution element.

In this embodiment, the aging treatment is performed by heating the forging after the quenching treatment step at the temperature of 180° C. to 220° C. for 0.5 hours to 1.5 hours. When the processing temperature is less than 180° C. or the processing time is less than 0.5 hours, Mgₜ Si based precipitates for improving tensile strength cannot be sufficiently grown. When the processing temperature exceeds 220° C., the Mg₂Si based precipitate becomes too coarse to improve tensile strength sufficiently.

As described above, in the method of producing the aluminum alloy forging according to the present invention, the content of each element is set within the predetermined range, and the processing condition at each processing step is set within the predetermined range. Thus, it is possible to produce an aluminum alloy forging excellent in mechanical properties at normal temperature and hard to generate recrystallized grains.

Next, the composition of the “aluminum alloy” in the above-described aluminum alloy forging and the method of producing the aluminum alloy forging according to the present invention will be described in detail. The aluminum alloy consists of: 0.15 to 1.0 mass % of Cu; 0.6 mass % to 1.3 mass % of Mg; 0.60 mass % to 1.45 mass % of Si; 0.03 mass % to 1.0 mass % of Mn; 0.2 mass % to 0.4 mass % of Fe; 0.03 mass % to 0.4 mass % of Cr; 0.012 mass % to 0.035 mass % of Ti; 0.0001 mass % to 0.03 mass % of B; 0.25 mass % or less of Zn; 0.05 mass % or less of Zr; and the balance being Al and inevitable impurities.

Si coexists with Mg to form a Mg₂Si based precipitate, which contributes to the improvement of the strength of the final product. Adding Si in excess of the amount of Mg that produces the Mg₂Si relative to the amount of Mg described below further increases the strength of the final product after the aging treatment. Therefore, the content of Si is desirably 0.60 mass % or more. On the other hand, when the content of Si exceeds 1.45 mass %, grain boundary precipitation of Si increases. Therefore, grain boundary embrittlement is likely to occur. This causes the deterioration of the plastic processability of the ingot and the deterioration of the toughness of the final product. Further, there is a possibility that the average particle diameter of the crystallized substance of the ingot exceeds the predetermined upper limit. Therefore, it is required that the content of Si be in the range of 0.60 mass % to 1.45 mass %.

Mg coexists with Si to form a Mg₂Si based precipitate, which contributes to the strength improvement of the final product. When the content of Mg is less than 0.6 mass %, the precipitation-strengthening may be less effective. On the other hand, when the content of Mg exceeds 1.3 mass %, not only the plastic processability of the ingot and the toughness of the final product may deteriorate but also the average particle diameter of the crystallized substance of the ingot may exceed the predetermined upper limit. Therefore, it is required that the content of Mg be in the range of 0.6 mass % to 1.3 mass %.

The Cu increases the apparent supersaturation amount of the Mg₂Si based precipitate to increase the Mg₂Si precipitation amount, which significantly facilitates the aging-hardening of the final product. When the content of Cu is less than 0.15 mass %, the Q-phase (Al—Cu—Mg—Si) effective as precipitation-strengthening is less likely to be generated, resulting in deterioration of the mechanical properties. On the other hand, when the content of Cu exceeds 1.0 mass %, the forging processability of the ingot and the toughness of the final product deteriorate, which may cause a significant reduction of the corrosion resistance. Therefore, it is required that the content of Cu be in the range of 0.15 mass % to 1.0 mass %.

Mn crystallizes as an AlMnSi phase, and non-crystallized Mn precipitates to suppress the recrystallization. The effect of suppressing the recrystallization makes crystal grains finer after the plastic working, resulting in improved toughness and corrosion resistance of the final product. When the content of Mn is less than 0.03 mass %, the above-described effects may be reduced. On the other hand, when the content of Mn exceeds 1.0 mass %, a huge intermetallic compound may be generated. Thus, the ingot structure of the present invention may not be met. Therefore, it is required that the content of Mn be in the range of 0.03 mass % to 1.0 mass %.

Cr crystallizes as an AlCrSi phase, and non-crystallized Cr precipitates to suppress recrystallization. The effect of suppressing the recrystallization makes the crystal grain finer after the plastic workings, resulting in improved toughness and corrosion resistance of the final product. When the content of Cr is less than 0.03 mass %, the above-described effect may be reduced. On the other hand, when the content of Cr exceeds 0.4 mass %, a huge intermetallic compound is generated, and the ingot structure of the present invention may not be satisfied. Therefore, it is required that the content of Cr be in the range of 0.03 mass % to 0.4 mass %.

Fe binds to Al and Si in an alloy to be crystallized to prevent coarsening of the crystal grain. When the content of Fe is less than 0.2 mass %, the above-described effects may not be obtained. When the content of Fe exceeds 0.4 mass %, coarse intermetallic compounds are generated, which may deteriorate the plastic processability. Therefore, it is required that the content of Fe be in the range of 0.2 mass % to 0.4 mass %.

Zn is treated as impurities. When the content of Zn exceeds 0.25 mass %, Zn accelerates corrosion of the aluminum itself and deteriorates the corrosion resistance. Therefore, it is required that the content of Zn be 0.25 mass % or less.

Zr is treated as impurities. When the content of Zr exceeds 0.05 mass %, the crystal grain miniaturization effect of the Al—Ti—B based alloy is weakened, resulting in decreased strength of the workpiece after the plastic working. Therefore, it is required that the content of Zr be less than or equal to 0.05 mass %.

Ti is an effective alloy element for miniaturizing a crystal grain and prevents ingot cracking or the like in the continuously cast rod. When the content of Ti is less than 0.012 mass %, the miniaturization effect cannot be obtained. On the other hand, when the content of Ti exceeds 0.035 mass %, a coarse Ti compound may be crystallized, resulting in degraded toughness. Therefore, it is required that the content of Ti be in the range of 0.012 mass % to 0.035 mass %.

B is an element effective in crystal grain miniaturization, like Ti. When the content of B is less than 0.0001 mass %, the effect cannot be obtained. On the other hand, when the content of B exceeds 0.03 mass %, toughness may deteriorate. Therefore, it is required that the content of B be in the range of 0.0001 mass % to 0.03 mass %.

### EXAMPLES

Next, some specific examples of the present invention will be described. It should be noted, however, that the present invention is not particularly limited to these examples.

### Examples 1 to 12

Circular cross-sectional continuously cast materials of a diameter of 54 mm were prepared using the aluminum alloys of the alloy compositions shown in Table 1. The continuously cast materials were each subjected to a homogenization heat treatment under the condition shown in Table 1. The resulting cast materials were each subjected to plastic working into a shape of a suspension arm component of an automobile shown in FIG. 1 under the condition shown in Table 1 to obtain a plastic worked product.

Next, under the conditions shown in Table 1, the plastic worked products were raised in temperature and subjected to the solution treatment. Thereafter, they were subjected to the quenching treatments shown in Table 1, then subjected to the aging treatment to obtain aluminum alloy forgings 1.

### Comparative Examples 1 to 5

Circular cross-sectional continuously cast materials of a diameter of 54 mm were prepared using the aluminum alloy of the alloy compositions shown in Table 2. The continuously cast materials were each subjected to a homogenization heat treatment under the condition shown in Table 2. The resulting cast materials were each subjected to plastic working into the shape of a suspension arm component of an automobile shown in FIG. 1 under the condition shown in Table 2 to obtain a plastic worked product.

Next, the plastic worked products were subjected to a temperature rise and a solution treatment under the conditions shown in Table 2, followed by the quenching treatments shown in Table 2, and followed by the aging treatments to obtain the aluminum alloy forgings 1.

The quenching was started when the entire forging was brought into contact with water.

TABLE 1

| | | | Ex. 1 | Ex. 2 | Ex. 3 | Ex. 4 | Ex . 5 | Ex. 6 |
|---|---|---|---|---|---|---|---|---|
| Alloy | Cu (mass %) | | 0.39 | 0.39 | 0.39 | 0.39 | 0.39 | 0.39 |
| components | Mg (mass %) | | 0.9 | 0.9 | 0.9 | 1.05 | 1.05 | 1.05 |
| | Si (mass %) | | 1.12 | 1.12 | 1.12 | 1.25 | 1.25 | 1.25 |
| | Mn (mass %) | | 0.5 | 0.5 | 0.5 | 0.5 | 0.5 | 0.5 |
| | Fe (mass %) | | 0.23 | 0.23 | 0.23 | 0.23 | 0.23 | 0.23 |
| | Cr (mass %) | | 0.13 | 0.13 | 0.13 | 0.13 | 0.13 | 0.13 |
| | Ti (mass %) | | 0.02 | 0.02 | 0.02 | 0.02 | 0.02 | 0.02 |
| | B (mass %) | | 0.004 | 0.001 | 0.004 | 0.004 | 0.004 | 0.004 |
| Condition/ | Homoge- | Temp. [° C.] | 470 | 470 | 470 | 470 | 470 | 470 |
| Evaluation | nization step | Holding time [min] | 420 | 420 | 420 | 420 | 420 | 420 |
| | Forging step | Temp. [° C.] | 500 | 500 | 500 | 500 | 500 | 500 |
| | Solution | Temp, rising rate | 240 | 240 | 240 | 180 | 180 | 22.5 |
| | treatment | [° C./min] | | | | | | |
| | step | Temp. [° C.] | 545 | 545 | 545 | 545 | 545 | 545 |
| | | Holding time [min] | 30 | 30 | 30 | 30 | 30 | 30 |
| | Quenching | Time until | 15 | 15 | 15 | 15 | 15 | 15 |
| | step | submerge [s] | | | | | | |
| | | Temp. [° C.] | 60 | 60 | 60 | 60 | 60 | 60 |
| | | Submersion time | 7 | 10 | 15 | 7 | 10 | 7 |
| | Artificial | Temp. [° C.] | 200 | 200 | 200 | 200 | 200 | 200 |
| | aging | Holding time [min] | 60 | 60 | 60 | 60 | 60 | 60 |
| | Q₁/Q₂ (Integral intensity ratio) | | 2.9 × 10⁻³ | 3.1 × 10⁻³ | 2.9 × 10⁻³ | 2.5 × 10⁻³ | 2.4 × 10⁻³ | 2.9 × 10⁻³ |
| | Proof stress (MPa) | | 370 | 368 | 370 | 381 | 384 | 373 |
| Overall evaluation | | | ⊚ | ⊚ | ⊚ | ⊚ | ⊚ | ⊚ |
| | | | Ex. 7 | Ex. 8 | Ex. 9 | Ex. 10 | Ex. 11 | Ex. 12 |
| Alloy | Cu (mass %) | | 0.3 | 0.3 | 0.3 | 0.39 | 0.39 | 0.39 |
| components | Mg (mass %) | | 0.75 | 0.75 | 0.75 | 1.2 | 1.2 | 1.2 |
| | Si (mass %) | | 1.2 | 1.2 | 1.2 | 1.32 | 1.32 | 1.32 |
| | Mn (mass %) | | 0.4 | 0.4 | 0.4 | 0.5 | 0.5 | 0.5 |
| | Fe (mass %) | | 0.23 | 0.23 | 0.23 | 0.23 | 0.23 | 0.23 |
| | Cr (mass %) | | 0.12 | 0.12 | 0.12 | 0.13 | 0.13 | 0.13 |
| | Ti (mass %) | | 0.02 | 0.02 | 0.02 | 0.02 | 0.02 | 0.02 |
| | B (mass %) | | 0.004 | 0.004 | 0.004 | 0.004 | 0.004 | 0.004 |
| Condition/ | Homoge- | Temp. [° C.] | 560 | 560 | 560 | 470 | 470 | 470 |
| Evaluation | nization step | Holding time [min] | 420 | 420 | 420 | 420 | 420 | 420 |
| | Forging step | Temp. [° C.] | 500 | 500 | 500 | 500 | 500 | 500 |
| | Solution | Temp, rising rate | 17.5 | 17.5 | 17.5 | 240 | 240 | 240 |
| | treatment | [° C./min] | | | | | | |
| | step | Temp. [° C.] | 540 | 540 | 540 | 545 | 545 | 545 |
| | | Holding time [min] | 30 | 30 | 30 | 30 | 30 | 30 |
| | Quenching | Time until | 15 | 15 | 15 | 60 | 60 | 5 |
| | step | submerge [s] | | | | | | |
| | | Temp. [° C.] | 60 | 60 | 60 | 60 | 60 | 60 |
| | | Submersion time | 10 | 7 | 10 | 7 | 10 | 7 |
| | Artificial | Temp. [° C.] | 200 | 200 | 200 | 195 | 195 | 195 |
| | aging | Holding time [min] | 60 | 60 | 50 | 90 | 90 | 90 |

| | | | | | | |
|---|---|---|---|---|---|---|
| Q₁/Q₂ (Integral intensity ratio) | 4.0 × 10⁻³ | 14.2 × 10⁻³ | 3.8 × 10⁻³ | 1.9 × 10⁻³ | 2.2 × 10⁻³ | 2.0 × 10⁻³ |
| Proof stress (MPa) | 347 | 345 | 349 | 388 | 389 | 389 |

| | | | | | | |
|---|---|---|---|---|---|---|
| Overall evaluation | ○ | ○ | ○ | ⊚ | ⊚ | ⊚ |

| | | | Comp. Ex. 1 | Comp. Ex. 2 | Comp. Ex. 3 | Comp. Ex. 4 | Comp. Ex. 5 |
|---|---|---|---|---|---|---|---|
| Alloy | Cu (mass %) | | 0.3 | 0.3 | 0.3 | 0.39 | 0.39 |
| components | Mg (mass%) | | 0.8 | 0.8 | 0.8 | 0.8 | 0.8 |
| | Si (mass %) | | 1.14 | 1.14 | 1.14 | 1.14 | 1.14 |
| | Mn (mass %) | | 0.5 | 0.5 | 0.5 | 0.5 | 0.5 |
| | Fe (mass %) | | 0.23 | 0.23 | 0.23 | 0.23 | 0.23 |
| | Cr (mass %) | | 0.13 | 0.13 | 0.13 | 0.13 | 0.13 |
| | Ti (mass %) | | 0.02 | 0.02 | 0.02 | 0.02 | 0.02 |
| | B (mass %) | | 0.004 | 0.004 | 0.004 | 0.004 | 0.004 |
| Condition/ | Homogenization | Temp. [° C.] | 470 | 470 | 470 | 500 | 500 |
| Evaluation | step | Holding time [min] | 420 | 420 | 420 | 420 | 420 |
| | Forging step | Temp. [° C.] | 500 | 500 | 500 | 500 | 500 |
| | Solution | Temp, rising rate [° C./min] | 2.67 | 2.67 | 2.67 | 1.33 | 1.33 |
| | treatment step | Temp. [° C.] | 530 | 530 | 530 | 530 | 530 |
| | | Holding time [min] | 15 | 30 | 30 | 15 | 30 |
| | Quenching step | Time until submerge [s] | 90 | 90 | 90 | 15 | 15 |
| | | Temp.[° C.] | 60 | 60 | 60 | 60 | 60 |
| | | Submersion time [min] | 0.5 | 1 | 10 | 0.5 | 10 |
| | Artificial aging | Temp. [° C.] | 170 | 170 | 170 | 200 | 200 |
| | | Holding time [min] | 60 | 60 | 60 | 60 | 60 |

| | | | | | |
|---|---|---|---|---|---|
| Q₁/Q₂ (Integral intensity ratio) | 9.0 × 10⁻² | 8.5 × 10⁻² | 7.6 × 10⁻² | 8.1 × 10⁻² | 7.8 × 10⁻² |
| Proof stress (MPa) | 270 | 281 | 280 | 324 | 320 |

| | | | | | |
|---|---|---|---|---|---|
| Overall evaluation | × | × | × | Δ | Δ |

Each aluminum alloy forging obtained as described above was evaluated according to the evaluation method described below.

### <Proof Stress Evaluation Method at Normal Temperature>

Among the obtained aluminum alloy forgings, a tensile test piece of a gauge distance of 25.4 mm and a parallel-portion diameter of 6.4 mm was taken. By performing a normal temperature (25° C.) tensile test for the tensile test piece, the proof stress was measured, and evaluation was performed based on the following criteria.

### (Criteria)

“⊚”: Proof stress at normal temperature is greater than or equal to 360 MPa.
“◯”: Proof stress at normal temperature is greater than or equal to 340 MPa and less than 360 MPa
“Δ”: Proof stress at normal temperature is greater than or equal to 320 MPa and less than 340 MPa.
“X”: Proof stress at normal temperature is less than 320 MPa.

As is apparent from Tables 1 to 2, the aluminum alloy forgings of Examples 1 to 12 produced by the production method of the present invention were excellent in proof stress at normal temperature.

On the other hand, as shown in Table 2, the aluminum alloy forgings of Comparative Examples 1 to 5, which deviated from the specified scope of the present invention, were inferior to the proof stress at normal temperature.

### <Integral Strength Measurement Method of Diffraction Peak of Al Phase and AlFeSi Phase of Aluminum-Alloy Forging>

For each aluminum alloy cast material and each aluminum alloy extruded material, an X-ray diffraction measurement was performed using an X-ray diffractometer (SmartLab) manufactured by Rigaku Corporation. A plate of 10 mm×10 mm×2 mm in thickness was taken from the forging and used as an X-ray diffraction measurement sample. In the X-ray diffraction pattern obtained by the X-ray diffraction measurement, the diffraction peak of the (200) plane of the Al phase was identified, and the integral value of the diffraction peak strength of the (200) plane of the Al phase (integrated intensity Q₂ of the diffraction peak) was determined. Further, the diffraction peak of the AlFeMnSi phase was also identified, and the integral value of the diffraction peak strength (integrated intensity Q₁ of the diffraction peak) of this AlFeMnSi phase was determined. The Q₁/Q₂ values were obtained from these results. The results are shown in Tables 1 and 2.

As shown in Table 1, Examples 1 to 12 show that Q₁/Q₂ is less than 6×10⁻².

In contrast, as shown in Table 2, Comparative Examples 1 to 5 show that Q₁/Q₂ is greater than 6×10⁻².

This application claims priority to Japanese Patent Application No. 2020-206753 filed on Dec. 14, 2020, the disclosure of which is incorporated herein by reference in its entirety.

The terms and expressions used herein are for illustration purposes only and are not used for limited interpretation, do not exclude any equivalents of the features shown and stated herein, and it should be recognized that the present invention allows various modifications within the scope of the present invention as claimed.

### INDUSTRIAL APPLICABILITY

The forging obtained by the production method of the aluminum alloy forging according to the present invention is excellent in mechanical strength at normal temperature. Therefore, the aluminum alloy forging according to the present invention is suitably used as a suspension system material such as a suspension arm component of an automobile, but is not particularly limited to such an application.

### DESCRIPTION OF SYMBOLS

1: Aluminum alloy forging

1. An aluminum alloy forging consisting of:
0.15 to 1.0 mass % of Cu; 0.6 mass % to 1.3 mass % of Mg; 0.60 mass % to 1.45 mass % of Si; 0.03 mass % to 1.0 mass % of Mn; 0.2 mass % to 0.4 mass % of Fe; 0.03 mass % to 0.4 mass % of Cr; 0.012 mass % to 0.035 mass % of Ti; 0.0001 mass % to 0.03 mass % of B; 0.25 mass % or less of Zn; 0.05 mass % or less of Zr; and the balance being Al and inevitable impurities,
wherein, when integrated intensity of a diffraction peak of an AlFeMnSi phase in an X-ray diffraction pattern obtained by an X-ray diffraction measurement of a cross-section of the forging is “Q₁” (cps·deg) and integrated intensity of a diffraction peak of a (200) plane of an Al phase is “Q₂” (cps·deg),
a value of Q₁/Q₂ is 6×10⁻² or less.

2. A method of producing the aluminum alloy forging as recited in claim 1, the method comprising:
a molten metal forming step of obtaining a molten metal;
a casting step of obtaining a casting by subjecting the molten metal obtained in the molten metal forming step to a casting process;
a homogenization heat treatment step of subjecting the casting obtained in the casting step to a homogenization heat treatment;
a forging step of obtaining a forging by subjecting the casting after the homogenization heat treatment step to a forging process;
a solution treatment step of subjecting the forging obtained in the forging step to a solution treatment;
a quenching treatment step of quenching the forging after the solution treatment step; and
an aging treatment step of subjecting the forging after the quenching treatment step to an aging treatment.

3. The method of producing an aluminum alloy forging as recited in claim 2,
wherein the homogenization heat treatment step performs a homogenization heat treatment of holding the casting obtained in the casting step at a temperature of 370° C. to 560° C. for 4 hours to 10 hours,
wherein the forging step performs a forging process on the casting after the homogenization heat treatment step at a heating temperature of 450° C. to 560° C.,
wherein the solution treatment step performs a solution treatment of raising a temperature from 20° C. to 500° C. at a temperature rising rate of 5.0° C./min or more and holding the forging at a temperature of 530° C. to 560° C. for 0.3 hours to 3 hours, on the forging obtained in the forging step,
wherein the quenching treatment step performs a quenching treatment of bringing an entire surface of the forging into contact with quenching water within 5 to 60 seconds after the solution treatment step in a water bath for more than 5 minutes and 40 minutes or less, and
wherein the aging treatment step performs an aging treatment of heating the forging after the quenching treatment step at a temperature of 180° C. to 220° C. for 0.5 to 1.5 hours.
